(19) United States
(12) Patent Application Publication
(10) Pub. No.: US 2013/0123409 A1
(43) Pub. Date: May 16, 2013

(54) SOLVENT-BORNE PRODUCTS CONTAINING SHORT-CUT MICROFIBERS

(71) Applicant: Eastman Chemical Company, Kingsport, TN (US)

(72) Inventors: Mark Dwight Clark, Kingsport, TN (US); Chris Delbert Anderson, Perrysburg, OH (US)

(73) Assignee: Eastman Chemical Company, Kingsport, TN (US)

(21) Appl. No.: 13/671,682

(22) Filed: Nov. 8, 2012

Related U.S. Application Data
(60) Provisional application No. 61/558,744, filed on Nov. 11, 2011.

(51) Int. Cl. C09D 101/32

(52) U.S. Cl. CPC C09D 101/32
USPC 524/315

(57) ABSTRACT

Solvent-borne products enhanced with short-cut microfibers and processes for making such enhanced solvent-borne products are disclosed. The short-cut microfibers can function to impart enhanced physical properties (e.g., enhanced thixotropy) to the solvent-borne products. Solvent-borne products suitable for enhancement with short-cut microfibers include flowable products (e.g., coatings, sealants, caulks, mastics, and adhesives) that can be applied to a substrate and that adhere to the substrate when dried and/or cured.

### CROSS REFERENCES TO RELATED APPLICATIONS

This application is an original application and claims priority to provisional application Ser. No. 61/558,744, filed on Nov. 11, 2011.

### BACKGROUND

1. Field of the Invention

The present invention relates to solvent-borne products having enhanced physical properties. More particularly, the present invention concerns the use of small-diameter fibers as thixotrope agents in solvent-borne products.

2. Description of the Related Art

Thixotrope agents are used in various solvent-borne products, such as coatings, adhesives, sealants, caulks, and mastics, in order to improve the application and/or workability of these products. More specifically, thixotrope agents are generally incorporated into the solvent-borne products to obtain better control over the viscosity of the products.

Various types of thixotrope agents are utilized in solvent-borne products. For example, particulate thixotrope agents, such as powder silica, bentonite, and starch, control the viscosity of the solvent-borne product by forming networks within it via hydrogen bonding. However, particulate thixotrope agents have a number of drawbacks. For instance, particulate thixotrope agents provide very little or no reinforcement to the solvent-borne product. Furthermore, particulate thixotrope agents are generally inefficient, requiring large quantities of the particulate thixotrope agent to obtain the desired viscosity control in the solvent-borne product. This can increase the overall costs of producing the solvent-borne product. Moreover, the ability of the particulate thixotrope agents to regulate viscosity is greatly affected by the type of processing techniques used and is particularly vulnerable to aging and temperature changes.

Fibrous thixotrope agents are known to be suitable replacements for particulate thixotrope agents. Fibrous thixotrope agents involve incorporating various types of small-diameter fibers (e.g., less than 100 microns) into the solvent-borne product to thereby regulate its viscosity and provide reinforcement to the product. Fibrous thixotrope agents have some advantages over particulate thixotrope agents; however, fibrous thixotrope agents also exhibit a number of drawbacks. For instance, depending on the type of material used, fibrous thixotrope agents can be quite brittle and can lead to eventual cracking of the composite formed by the solvent-borne product. In addition, some types of fibrous thixotrope agents may wick moisture from the environment into the composite formed by the solvent-borne product, thus making the composite unsuitable for some applications. Furthermore, fibrous thixotrope agents may induce such high viscosities that it becomes difficult to disperse and apply the solvent-borne product incorporating them.

Therefore, a need exists for a thixotrope agent that effectively provides the ability to control the viscosity of solvent-borne products and overcomes or minimizes the disadvantages of conventional thixotrope agents.

### SUMMARY

One embodiment of the present invention concerns a process for producing a solvent-borne product suitable for application to a substrate and capable of adhering to the substrate when the solvent-borne product is dried and/or cured thereon. The process comprises: (a) combining an initial medium comprising a non-aqueous solvent with a plurality of short-cut multi-component fibers having a length of not more than 25 millimeters, wherein each of the short-cut multi-component fibers have a plurality of discrete solvent insoluble segments and at least one solvent soluble component that substantially isolates the discrete solvent insoluble segments from one another; and (b) dissolving at least a portion of the solvent soluble component in the initial medium without substantially dissolving the solvent insoluble segments, thereby releasing the discrete solvent insoluble segments in the form of short-cut microfibers. The short-cut microfibers have a length of not more than 25 millimeters, an effective diameter of not more than 25 microns, and a longitudinal aspect ratio of at least 50:1. The solvent-borne product comprises at least a portion of the short-cut microfibers, at least a portion of the non-aqueous solvent, and at least a portion of the dissolved solvent soluble component.

Another embodiment of the present invention concerns a solvent-borne product suitable for application to a substrate and capable of adhering to the substrate when the solvent-borne product is dried and/or cured thereon. The solvent-borne product comprises a non-aqueous solvent, a base polymer, a solvent soluble fiber-forming polymer dissolved in the non-aqueous solvent, and a plurality of short-cut microfibers. The short-cut microfibers have a length of not more than 25 millimeters, an effective diameter of not more than 25 microns, and a longitudinal aspect ratio of at least 50:1.

### DETAILED DESCRIPTION

In one embodiment, the present invention concerns solvent-borne products containing short-cut microfibers. In another embodiment, the present invention concerns a process for incorporating short-cut microfibers into solvent-borne products through the use of short-cut multi-component fibers.

The solvent-borne products provided in accordance with certain embodiments of the present invention can include any solvent-borne product that is suitable for application to a substrate and is capable of adhering to the substrate when the solvent-borne product has dried and/or has been cured thereon. In one embodiment, the solvent-borne product can be selected from the group consisting of a coating, a sealant, a caulk, a mastic, and an adhesive. When the solvent-borne product is a coating, such a coating can be, for example, an automotive coating, an architectural coating, an industrial coating, or a marine coating.

The solvent-borne product can include a number of components that can be added at various stages during the production of the solvent-borne product. For example, the solvent-borne product can contain at least the following components: a non-aqueous solvent, a base polymer, a solvent soluble component, and a plurality of short-cut microfibers. In certain embodiments, the solvent-borne product can also contain pigments and/or fillers.

As discussed in detail below, the solvent soluble component and the short-cut microfibers present in the solvent-borne product can originate from short-cut multi-component fibers that have been added to an initial medium under conditions sufficient to cause substantial dissolution of the solvent soluble component in the non-aqueous solvent. In one embodiment, the initial medium to which the short-cut multi-component fibers are added can be formed entirely of the non-aqueous solvent. In another embodiment, the initial medium to which the short-cut multi-component fibers are added can be a pigment grind comprising the pigment, at least a portion of the non-aqueous solvent, optionally the filler, and optionally various grinding aids; but, not containing the base polymer. In yet another embodiment, the initial medium to which the short-cut multi-component fibers are added contains all of the components of the solvent-borne product, except the solvent soluble component and the short-cut microfibers. In this later embodiment, the initial medium can be, for example, a fully-functional coating, sealant, caulk, mastic, or adhesive that has not yet been enhanced with short-cut microfibers.

The non-aqueous solvent present in the initial medium can consist of one solvent or can be a mixture of two or more solvents. In one embodiment, the non-aqueous solvent is in a solvent class selected from the group consisting of hydrocarbons, alcohols, esters, ketones, glycols, glycol derivatives, and mixtures thereof. Additionally or alternatively, the non-aqueous solvent can be selected from the group consisting of xylene, toluene, ethyl benzene, ethylene glycol, formaldehyde, hexane, methanol, styrene, benzene, methylene chloride, 1,1,1,-trichloroethane, ethoxyethyl propionate, naptha, mineral spirits, acetone, methyl ethyl ketone, methyl isobutyl ketone, methyl amyl ketone, methyl propyl ketone, 2-propoxyethanol, 2-butoxyethanol, ethyl 3-ethoxypropionate, ethanol, methanol isopropyl alcohol, diacetone alcohol, ethylene glycol monobutyl ether acetate, ethyl acetate, propyl acetate, isopropyl acetate, butyl acetate, isobutyl acetate, diethylene glycol ethyl ether, propylene glycol methyl acetate, ethylene glycol butyl acetate, propylene glycol monomethyl ether, diethylene glycol methyl ether, propylene glycol monobutyl ether, diethylene glycol ethyl ether, propylene glycol monopropyl ether, ethylene glycol monopropyl ether, ethylene glycol monobutyl ether, N-methylpyrrolidone, ethyl 3-ethoxypropionate, and mixtures thereof. The solvent-borne product can comprise the non-aqueous solvent in an amount of at least 5, 10, 15, or 20 weight percent and/or not more than 95, 90, 85, or 80 weight percent based on the total weight of the solvent-borne product.

The base polymer present in the solvent-borne product can consist of a single base polymer or can be multiple base polymers. In one embodiment, the base polymer can be any polymer or mixture of polymers capable of adhering to a substrate when the solvent-borne product is dried and/or cured on the substrate. The base polymer can be selected from the group consisting of acrylics, vinyl-acrylics, epoxides, alkyds, polyesters, styrene block copolymers, polyurethanes, butyl rubbers, ethylene vinyl acetates, starches, polyisobutylenes, dextrins, chlorinated rubbers, EPDM (ethylene propylene diene monomer) rubbers, nitriles, cyanoacrylates, polyolefins, polyvinyl acetate emulsions and derivatives, silicones, soy-based polymers, polyesters, cellulose esters, animal glues, caseins, polyamides, polysulfides, natural rubbers, and combinations thereof. The solvent-borne product can comprise the base polymer in an amount of at least 5, 10, 15, or 20 weight percent and/or not more than 95, 90, 85, or 80 weight percent based on the total weight of the solvent-borne product.

In one embodiment, the solvent-borne product and/or the initial medium contain little or no water. Accordingly, the solvent-borne product can comprise water in an amount of not more than 10, 5, 2, or 1 weight percent based on the total weight of the solvent-borne product and/or the initial medium can comprise water in an amount of not more than 10, 5, 2, or 1 weight percent based on the total weight of the initial medium.

As mentioned above, to make the solvent-borne product, the short-cut microfibers and the solvent soluble component can be added to the initial medium through the use of short-cut multi-component fibers. Each of the short-cut multi-component fibers can comprise a plurality of discrete solvent insoluble segments and at least one solvent soluble component that substantially isolates the discrete solvent insoluble segments from one another.

The short-cut multi-component fibers can have a number of different cross-sectional configurations including, for example, islands-in-the-sea, striped, segmented pie, sheath-core, and combinations thereof. In one embodiment, the short-cut multi-component fibers have an islands-in-the-sea configuration, with the solvent insoluble segments forming the islands and the solvent soluble component forming the sea. Each short-cut multi-component fiber can comprise at least 5, 10, 20, or 30 individual solvent insoluble segments.

The solvent soluble component of the short-cut multi-component fiber can be formed of a fiber-forming polymer. As used herein, “fiber-forming polymer” is understood to encompass any polymer that can be formed into a fiber using conventional melt extrusion techniques.

In one embodiment, the solvent soluble component, in its undissolved state, exhibits a glass transition temperature of at least 40° C., 45° C., 50° C., 55° C., or 57° C. Further, the solvent soluble component, in its undissolved state, can exhibit a melt viscosity of not more than 12,000, 10,000, 8,000, or 6,000 and/or at least 500 1,000, or 2,000 poise measured at 240° C. at a strain rate of 1 radians per second. In certain embodiments, the solvent soluble component can be selected from the group consisting of cellulose esters, acrylic homopolymers, acrylic copolymers, styrenic homopolymers, styrenic copolymers, and combinations thereof.

The solvent soluble component is at least partially dissolvable in the non-aqueous solvent of the initial medium. In one embodiment, the non-aqueous solvent has a Hildebrand solubility parameter of at least 10, 14, or 16 and/or not more than 30, 26, or 24 MPa^{1/2}. The solvent soluble component dissolves more readily in the non-aqueous solvent if they exhibit similar Hildebrand solubility parameters. Therefore, the solvent soluble component can have a Hildebrand solubility parameter within 10, 8, 6, 4, or 2 MPa^{1/2} of the Hildebrand solubility parameter of the non-aqueous solvent.

The multi-component fibers described herein are referred to as “short-cut” since they have been previously cut to a relatively short predetermined length. For example, the short-cut multi-component fibers can have a length of at least 0.1, 0.25, 0.5, or 1.0 millimeter and/or not more than 25, 15, 10, 7.5, 5, or 2.5 millimeters. Additionally, the short-cut multi-component fibers can have an effective diameter of at least 4, 8, 10, or 12 microns and/or not more than 100, 75, 50, or 25 microns. Furthermore, the short-cut multi-component fibers can have a longitudinal aspect ratio of at least 5:1, 10:1, or 20:1 and/or not more than 800:1, 400:1, or 200:1.

The short-cut microfibers present in the final solvent-borne product can be incorporated by adding the short-cut multi-component fibers to the initial medium. As mentioned above, the initial medium can be any medium containing a non-aqueous solvent. Thus, the short-cut multi-component fibers can be added to the solvent-borne product at any point during its production as long as the non-aqueous solvent is present. In one embodiment, the short-cut multi-component fibers can be added to a fully-functional solvent-borne product after its production. Alternatively, the short-cut multi-component fibers can be added to an initial medium that contains the non-aqueous solvent, but lacks one or more components of the final solvent-borne product. When the initial medium is a pigment grind, the multi-component fibers can be added to the pigment grind before, during, and/or after grinding of the pigment.

When the short-cut multi-component fibers are added to the initial medium, at least a portion of the solvent soluble component of the short-cut multi-component fibers dissolves in the non-aqueous solvent of the initial medium, while the solvent insoluble segments remain undissolved. This dissolution of the solvent soluble component releases the discrete solvent insoluble segments from the short-cut multi-component fibers in the form of short-cut microfibers. The dissolution of the solvent soluble component can be carried out at a temperature of not more than 50° C., 40° C., 30° C., or 25° C. and can cause at least 75, 90, 95, or 99 weight percent of the solvent soluble component to dissolve in the non-aqueous solvent.

The short-cut microfibers released into the initial medium (and the solvent insoluble segments from which the short-cut microfibers are derived) can be formed from a synthetic polymer. In one embodiment, the short-cut microfibers and solvent insoluble segments are formed from a material selected from the group consisting of polyolefins, polyesters, copolyesters, polyamides, polylactides, polycaprolactones, polycarbonates, polyurethanes, cellulose esters, acrylics, polyvinyl chlorides, and blends thereof.

The short-cut microfibers released into the initial medium can have a length of at least 0.05, 0.1, 0.5, or 1 millimeter and/or not more than 25, 15, 10, 7.5, 5, or 2.5 millimeters. In addition, the short-cut microfibers can have an effective diameter of at least 0.05, 0.1, 0.5, or 1 micron and/or not more than 10, 5, 3.5, or 2 microns. Furthermore, the short-cut microfibers can have a longitudinal aspect ratio of at least 50:1, 100:1, 250:1, or 500:1 and/or not more than 5,000:1, 2,500:1, 1,000:1, or 800:1. Additionally or alternatively, the short-cut microfibers can have a transverse aspect ratio of not more than 20:1, 10:1, 5:1, 2:1, 1.5:1, or 1.1:1.

The short-cut microfibers can have a cross-sectional shape selected from the group consisting of round, wedge-shaped, substantially rectangular, and substantially trapezoidal. In one embodiment, the solvent-borne product comprises the short-cut microfibers in an amount of at least 0.01, 0.05, 0.1, or 0.5 weight percent and/or not more than 10, 5, 2, 1, or 0.5 weight percent based on the total weight of the solvent-borne product. Further, the solvent-borne product can comprise the solvent soluble component in an amount of at least 0.005, 0.01, 0.05, or 0.1 weight percent and/or not more than 5, 2.5, 1, 0.5, or 0.1 weight percent based on the total weight of the solvent-borne product.

The dissolving of the solvent soluble component in the initial medium forms a short-cut-microfiber-containing mixture comprising the initial medium, the short-cut microfibers, and the solvent soluble component dissolved in the non-aqueous solvent. In one embodiment, various other compounds (e.g., base polymers, additional solvents, and/or pigments) can be added to the short-cut-microfiber-containing mixture to form the final solvent-borne product. In another embodiment, the short-cut-microfiber-containing mixture is the final solvent-borne product.

The short-cut microfibers can function to enhance the physical properties (e.g., thixotropy, strength, and/or durability) of the solvent-borne product before and/or after the solvent-borne product has dried and/or cured. One particularly advantageous function of the short-cut microfibers can be as a fibrous thixotrope agent used to control the viscosity of the solvent-borne product prior to drying and/or curing.

The inventors hereby state their intent to rely on the Doctrine of Equivalents to determine and assess the reasonably fair scope of the present invention as it pertains to any apparatus not materially departing from but outside the literal scope of the invention as set forth in the following claims.

### EXAMPLES

### Example 1

Eastman Tenite® Butyrate from Eastman Chemical Company and polypropylene HIVAL 2412 from Ashland, Inc. were spun into bicomponent islands-in-the-sea cross-section fibers with 37 island fibers using a bicomponent extrusion line. The primary extruder fed polypropylene melt to form the islands in the islands-in-the-sea fiber cross-section structure. The secondary extruder fed the Tenite® Butyrate polymer melt to form the sea in the islands-in-sea bicomponent fiber.

These islands-in-sea bicomponent fibers were made using a spinneret with 72 holes and a throughput rate of 0.23 gms/hole/minute. The polymer ratio between “islands” polypropylene and “sea” Tenite® Butyrate was 50% to 50%. These bicomponent fibers were spun using an extrusion temperature of 245° C. for the polypropylene component and 245° C. for the Tenite Butyrate component. The bicomponent fiber contains a multiplicity of filaments (74 filaments) and was melt spun at a speed of about 500 meters/minute, forming filaments with a nominal denier per filament of about 4.2. These filaments comprised polypropylene microfiber “islands” having an average diameter of approximately 2.5 microns.

### Example 2

The drawn islands-in-sea bicomponent fibers of Example 1 were cut into short length fibers of 1.5 millimeter lengths, thereby, producing short length bicomponent fibers with 37 islands-in-sea cross-section configurations. These short cut bicomponent fibers comprised “islands” of polypropylene and “sea” of Tenite® Butyrate polymer. The cross-sectional distribution of islands and sea was essentially consistent along the length of these short cut bicomponent fibers.

### Example 3

A solvent-borne coating formulation was prepared as follows: to 29.3 grams of butyl acetate, 58.7 grams of ethyl acetate, and 3.9 grams of isopropyl alcohol were added amounts described in Table 1 of Tenite® Butyrate polymer and the short cut microfiber of Example 2 to yield a liquid formulation with a total solids content (polymer and fiber) of 8.1%. These mixtures were placed on a roller for 24 hours in order to allow both the Tenite® Butyrate polymer pellets and the Tenite® Butyrate polymer present as the sea in the short cut bicomponent fibers of Example 2 to dissolve in the solvent mixture. After 24 hours, the samples were vigorously agitated, and then allowed to stand for one hour. Low shear viscosity measurements were made on the samples using a Brookfield Model DV-II+ Viscometer equipped with a #2 spindle at a shear rate of 0.6 rpm. It can be clearly seen from the data in Table 1 that inclusion of the polypropylene microfibers in the solvent-borne coating formulation significantly enhances the low-shear viscosity of the material.

TABLE 1

| | grams Tenite | grams fiber | wt % PP microfiber | viscosity |
|---|---|---|---|---|
| Sample | Butyrate | from Ex. 2 | in coating | (cps) |
| Control | 8.1 | — | 0 | 250 |
| A | 7.9 | 0.2 | 0.10 | 1550 |
| B | 7.6 | 0.5 | 0.25 | 6800 |
| C | 7.1 | 1.0 | 0.50 | 27450 |
| D | 6.1 | 2.0 | 1.00 | 48500 |

What is claimed is:

1. A solvent-borne product suitable for application to a substrate and capable of adhering to said substrate when said solvent-borne product is dried and/or cured thereon, said solvent-borne product comprising:
a non-aqueous solvent;
a base polymer;
a solvent soluble fiber-forming polymer dissolved in said non-aqueous solvent; and
a plurality of short-cut microfibers having a length of not more than 25 millimeters, an effective diameter of not more than 25 microns, and a longitudinal aspect ratio of at least 50:1.

2. The solvent-borne product according to claim 1, wherein said solvent-borne product is selected from the group consisting of a coating, a sealant, a caulk, a mastic, and an adhesive.

3. The solvent-borne product according to claim 1, wherein said solvent soluble fiber-forming polymer in its undissolved state exhibits a glass transition temperature of at least 40° C. and a melt viscosity of not more than 12,000 poise measured at 240° C. at a strain rate of 1 radians per second.

4. The solvent-borne product according to claim 1, wherein said non-aqueous solvent has a Hildebrand solubility parameter of at least 10 and not more than 30 MPa^{1/2}, wherein said fiber forming solvent soluble component has a Hildebrand solubility parameter within 10 MPa^{1/2} of the Hildebrand solubility parameter of said non-aqueous solvent.

5. The solvent-borne product according to claim 1, wherein said non-aqueous solvent has a Hildebrand solubility parameter of at least 14 and not more than 26 MPa^{1/2}, wherein said fiber forming solvent soluble component has a Hildebrand solubility parameter within 4 MPa^{1/2} of the Hildebrand solubility parameter of said non-aqueous solvent.

6. The solvent-borne product according to claim 1, wherein said non-aqueous solvent is a mixture of two or more solvents.

7. The solvent-borne product according to claim 1, wherein said non-aqueous solvent is in a solvent class selected from the group consisting of hydrocarbons, alcohols, esters, ketones, glycols, glycol derivatives, and mixtures thereof.

8. The solvent-borne product according to claim 1, wherein said non-aqueous solvent is selected from the group consisting of xylene, toluene, ethyl benzene, ethylene glycol, formaldehyde, hexane, methanol, styrene, benzene, methylene chloride, 1,1,1,-trichloroethane, ethoxyethyl propionate, naptha, mineral spirits, acetone, methyl ethyl ketone, methyl isobutyl ketone, methyl amyl ketone, methyl propyl ketone, 2-propoxyethanol, 2-butoxyethanol, ethyl 3-ethoxypropionate, ethanol, methanol isopropyl alcohol, diacetone alcohol, ethylene glycol monobutyl ether acetate, ethyl acetate, propyl acetate, isopropyl acetate, butyl acetate, isobutyl acetate diethylene glycol ethyl ether, propylene glycol methyl acetate, ethylene glycol butyl acetate, propylene glycol monomethyl ether, diethylene glycol methyl ether, propylene glycol monobutyl ether, diethylene glycol ethyl ether, propylene glycol monopropyl ether, ethylene glycol monopropyl ether, ethylene glycol monobutyl ether, N-methylpyrrolidone, ethyl 3-ethoxypropionate, and mixtures thereof.

9. The solvent-borne product according to claim 1, wherein said solvent soluble fiber-forming component is selected from the group consisting of cellulose esters, acrylic homopolymers, acrylic copolymers, styrenic homopolymers, styrenic copolymers, and combinations thereof.

10. The solvent-borne product according to claim 1, wherein said solvent-borne product comprises said solvent soluble fiber-forming polymer in an amount of at least 0.05 weight percent and not more than 5 weight percent based on the total weight of said solvent-borne product, wherein said solvent-borne product comprises said short-cut microfibers in an amount of at least 0.01 weight percent and not more than 10 weight percent based on the total weight of said solvent-borne product, wherein said solvent-borne product comprises said non-aqueous solvent in an amount of at least 5 weight percent and not more than 95 weight percent based on the total weight of said solvent-borne product, wherein said solvent-borne product comprises water in an amount of not more than 10 weight percent based on the total weight of said solvent-borne product.

11. The solvent-borne product according to claim 1, wherein said base polymer is capable of adhering to said substrate when said solvent-borne product is dried and/or cured.

12. The solvent-borne product according to claim 1, wherein said short-cut microfibers have a length of at least 0.5 millimeter and not more than 5 millimeters, an effective diameter of at least 0.5 micron and not more than 3.5 microns, and a longitudinal aspect ratio of at least 100:1 and not more than 2,500:1.

13. The process according to claim 1, wherein said short-cut microfibers are formed of a synthetic polymer.

14. The solvent-borne product according to claim 1, wherein said short-cut microfibers are formed of a material selected from the group consisting of polyolefins, polyesters, copolyesters, polyamides, polylactides, polycaprolactones, polycarbonates, polyurethanes, cellulose esters, acrylics, polyvinyl chlorides, and blends thereof.

15. A process for producing a solvent-borne product suitable for application to a substrate and capable of adhering to said substrate when said solvent-borne product is dried and/or cured thereon, said process comprising:
(a) combining a plurality of short-cut multi-component fibers with an initial medium comprising a non-aqueous solvent, wherein said short-cut multi-component fibers have a length of not more than 25 millimeters, wherein each of said short-cut multi-component fibers comprises a plurality of discrete solvent insoluble segments and at least one solvent soluble component that substantially isolates said discrete solvent insoluble segments from one another; and
(b) dissolving at least a portion of said solvent soluble component in said initial medium without substantially dissolving said solvent insoluble segments in said initial medium thereby releasing said discrete solvent insoluble segments in the form of short-cut microfibers, wherein said short-cut microfibers have a length of not more than 25 millimeters, an effective diameter of not more than 25 microns, and a longitudinal aspect ratio of at least 50:1,
wherein said solvent-borne product comprises at least a portion of said short-cut microfibers, at least a portion of said non-aqueous solvent, and at least a portion of the dissolved solvent soluble component.

16. The process according to claim 15, further comprising, subsequent to step (b), combining at least a portion of said short-cut microfibers, at least a portion of said non-aqueous solvent, and at least a portion of the dissolved solvent soluble component with one or more additional components to thereby form said solvent-borne product.

17. The process according to claim 15, wherein said dissolving is carried out at a temperature of not more than 50° C. and dissolves at least 95 weight percent of said solvent soluble component.

18. The process according to claim 15, wherein said solvent soluble component is selected from the group consisting of cellulose esters, acrylic homopolymers, acrylic copolymers, styrenic homopolymers, styrenic copolymers, and combinations thereof.

19. The process according to claim 15, wherein said non-aqueous solvent is in a solvent class selected from the group consisting of hydrocarbons, alcohols, esters, ketones, glycols, glycol derivatives, and mixtures thereof.

20. The process according to claim 15, wherein said non-aqueous solvent is selected from the group consisting of xylene, toluene, ethyl benzene, ethylene glycol, formaldehyde, hexane, methanol, styrene, benzene, methylene chloride, 1,1,1,-trichloroethane, ethoxyethyl propionate, naptha, mineral spirits, acetone, methyl ethyl ketone, methyl isobutyl ketone, methyl amyl ketone, methyl propyl ketone, 2-propoxyethanol, 2-butoxyethanol, ethyl 3-ethoxypropionate, ethanol, methanol isopropyl alcohol, diacetone alcohol, ethylene glycol monobutyl ether acetate, ethyl acetate, propyl acetate, isopropyl acetate, butyl acetate, isobutyl acetate diethylene glycol ethyl ether, propylene glycol methyl acetate, ethylene glycol butyl acetate, propylene glycol monomethyl ether, diethylene glycol methyl ether, propylene glycol monobutyl ether, diethylene glycol ethyl ether, propylene glycol monopropyl ether, ethylene glycol monopropyl ether, ethylene glycol monobutyl ether, N-methylpyrrolidone, ethyl 3-ethoxypropionate, and mixtures thereof.
